(19) United States
(12) Patent Application Publication
(10) Pub. No.: US 2009/0177124 A1
(43) Pub. Date: Jul. 9, 2009

(54) Sleep apnea prevention and relief device

(76) Inventors: John W. Silwa, Los Altos Hills, CA (US); Bryan T. Oronsky, Los Altos, CA (US)

Correspondence Address: David W. Collins - Intellectual Property Law, Suite 100, 512 E. Whitehouse Canyon Road, Green Valley, AZ, 85614, US

(21) Appl. No.: 12/291,631

(22) Filed: Nov. 10, 2008

Related U.S. Application Data
(60) Provisional application No. 61/002,364, filed on Nov. 8, 2007.

(51) Int. Cl. A61H 7/00

(52) U.S. Cl. 601/6

(57) ABSTRACT

A sleep apnea prevention and relief device is provided that is useful for a patient diagnosed with obstructive sleep apnea. For example, a form-fitting neck device is provided with a suction generation or creation means to create continuous or lasting negative pressure upon or around the neck in order to urge substantially outward expansion of the soft tissues that are compressing the pharynx and creating the obstruction.

### CROSS-REFERENCE TO RELATED APPLICATION

The present application claims priority from provisional application Ser. No. 61/002,364, filed Nov. 8, 2007, the contents of which are incorporated herein by reference.

### BACKGROUND OF THE INVENTION

Obstructive sleep apnea (OSA) is a sleep disorder affecting approximately 20 million Americans that involves recurrent episodes of upper airway obstruction during sleep. Patients with the disorder are most often overweight, with increased superficial neck fat and peripharyngeal infiltration of adipose tissue which predispose to the development of apnea as a result of compression and narrowing of the upper airways, the typical site of obstruction. The obese OSA phenotype, compounded by decreased muscle tone during sleep and the pull of gravity in a supine position, further contributes to airway collapse. Other predisposing mechanical factors include increased size of the soft palate and tongue, enlarged tonsils or adenoids, superficially located masses such as an enlarged thyroid which can cause external compression, nasal congestion, age-induced soft tissue laxity, and a retrognathic lower jaw that leaves insufficient room for the tongue.

Everyone with OSA snores and, while snoring from turbulent airflow is indicative of some degree of airway obstruction, what differentiates simple snoring from OSA is that in the latter the upper airways collapse, leading to apnea or hypopnea, which result in brief and often frequent arousals from sleep in order to restore airway patency.

The resulting sleep fragmentation and hypoxic and hyperbaric episodes from OSA are not only dangerous to the individual who is prone to hypertension, cor pulmonale, heart failure and fatal cardiac arrhythmias from the repeated adrenergic surges to stimulate the resumption of breathing but also pose a public health hazard from fall-asleep crashes at the wheel due to excessive daytime somnolence. Snoring itself, even in the absence of apnea or hypopnea, can lead to chronic insomnia of the bed partner as well as relationship or marital discord from sleep disturbance due to the excessive bedroom noise, an entity known as spousal arousal syndrome.

In mild cases of sleep apnea and simple snoring, non-supine positioning can relieve the obstruction. The classic remedy, which involves attaching a tennis ball to the back of pajamas, however, seldom works in OSA because these individuals usually demonstrate apnea in all positions.

In some cases, intraoral devices designed to bring the lower jaw and tongue forward may be beneficial, but nasal (n)-CPAP (Continuous Positive Airway Pressure) is usually the next treatment option. The machine includes a hose, leading from a fan, to a soft mask that covers the nose only or has inserts positioned in the nares. The pressurized air passing into the nostrils provides a pneumatic stent that holds the airways open, eliminating apneas, hypopneas and snoring. If delivered at two different pressure levels (for inspiration and expiration) it is referred to as BiPAP. Regular use of n-CPAP improves the patient's and their bed partners' quality of life, lessening the emotional complications of OSA which include moodiness, irritability, forgetfulness and depressive symptoms and improving daytime functioning, blood pressure, and insulin sensitivity.

However, the efficacy of CPAP machines is limited by noncompliance, as many individuals cannot tolerate the mask, the noise, or the high pressures necessary to prevent pharyngeal collapse. Air leaking around the mask can also cause eye irritation and dry out the nose, and the pressurized air can lead to excessive gas in the gastrointestinal tract. Intolerance of CPAP is a common indication for surgery, which has a very variable success rate and often the patient still requires CPAP after surgery anyway.

Accordingly, it would be desirable to provide an improved device and novel approach for treating obstructive sleep apnea and obstructive hypopnea and other respiratory events with an obstructive component. The present invention meets this need.

### BRIEF DESCRIPTION OF THE DRAWINGS

FIG. 1 depicts an inventive device mountable upon a patient's throat region and capable of contributing to the decompression of the neck/throat interior tissues whose contacting and collapsing would otherwise contributes to OSA.

FIG. 1A is a cross-sectional view of FIG. 1, taken along the line 1A-1A.

FIG. 1B is a cross-sectional view of FIG. 1, taken along the line 1B-1B.

### DETAILED DESCRIPTION OF THE INVENTION

In accordance with one aspect of the invention, in a patient diagnosed with obstructive sleep apnea, a form-fitting neck device is provided with a suction generation or creation means to create continuous or lasting negative pressure around the neck in order to urge substantially outward expansion of the soft tissues that are compressing the pharynx and creating the obstruction.

In one embodiment, the device consists of a rigid or semi-rigid membrane or diaphragm with a leak tight gel-seal or adhesive seal to the nearby neck tissue at its periphery. The suction-seal may incorporate some foam-like topographical conforming ability for patient comfort and the best possible sealing. The membrane is capable of maintaining a pressure difference or suction across it between the higher-pressure ambient and its lower-pressure tissue-facing side. Thus, establishment of a relative reduced pressure on the tissue side of the membrane, hereinafter referred to as a relative vacuum, causes the more easily deformable neck tissues to be pulled outwards toward the stiffer membrane. This inevitably encourages neck interior tissues behind the surface tissues under the device to be pulled away from each other and become decompressed or relaxed. This tends to open the obstructed air passage. It will be appreciated that the gel seal will apply a compressive load at the periphery equal to the total negative-pressure suction load. Thus, one should locate that peripheral seal where that compression does not contribute to passage closure in greater amounts than is being relieved by the suctioning action. The negative relative pressure may be provided as by a small electric diaphragm pump or even a manually operated squeeze bulb with a check valve. We note that although we depict in our figure the sealing gasket being relatively narrow, it may be wider and a portion of it may actually reside outside the outer periphery of the membrane.

The membrane defines a reduced-pressure region, causing the underlying tissue to bulge outward into that suctioned or reduced-pressure region. It should be obvious now given the idea that the membrane might have several sections each possibly with their own peripheral seals. Such multiple membrane chambers might be operated at different negative pressures or progressively negative pressures along a particular direction. One or several suction tubes might be utilized with several being more likely if there are several corresponding sub chambers being suctioned. Multiple such chambers might even be suctioned with different timing.

The degree of suction as measured, for example, in inches of water, might be constant or might be varied based on breathing patterns, snoring patterns, or bodily position. For example, in another embodiment, the device may generate intermittent sub atmospheric pressures to counteract the obstruction created by the negative intraluminal pressures during inspiration due to the Bernoulli effect while allowing passive expiration.

In another embodiment, the device may be combined with n-CPAP so that lower positive pressures would be needed, theoretically increasing compliance.

In another embodiment, the device may be combined with electrotherapy such as a muscle stimulator unit to enhance the tone of the pharyngeal dilator muscles, which are relaxed during sleep.

In another embodiment, the device may be combined with creams containing compounds such as caffeine, nicotine or other substances to increase sympathetic tone locally in order to promote contraction of the pharyngeal muscles, which are more relaxed during sleep. While it may seem paradoxical to suggest the use of compounds that might promote wakefulness in the treatment of a sleep disorder, it must be remembered that loss of sympathetic tone during sleep plays a potentially important role in the pathophysiology of OSA.

In another embodiment, the device may be combined with creams containing anti-inflammatory medications such as NSAIDs or corticosteroids to reduce peri-airway inflammation or edema.

Further, creams or other carriers containing a therapeutically effective amount of at least one of the cholinesterase inhibitor compounds such as donezepil HCL (Aricept) or a cholinomimetic such as Pilocarpine may be used in conjunction with the device of the invention to treat and prevent sleep apnea.

In another embodiment, the device may be combined with an ultrasonic device that infuses oxygen into the skin over the pharynx at point distal to the airway collapse, in this way effectively bypassing the obstruction.

The concept behind the device is similar in principle to the operation of the bulky iron lung widely used in the 1950s, which used non-invasive negative pressure ventilation to treat paralytic poliomyelitis during the poliovirus epidemic. Subsequently, less bulky, more portable negative-pressure ventilators were developed. They include the poncho wrap (or jacket) ventilator (Numowrap, Respironics, Inc., Pittsburgh, Pa.), and the cuirass (or tortoise shell), both of which are placed over the chest and abdomen.

The application of a device such as ours is clearly non-obvious because the use of negative pressure ventilation, both invasive and non-invasive, has been linked with the very problem we are purporting to address: obstructive apneas associated with severe oxygen desaturations. This problem is related to the lack of preinspiratory contraction of pharyngeal muscles that prevents collapse of upper airway structures during a normal patient-initiated breath. Thus, the prior art teaches away from our solution.

However, we believe this device would decrease, rather than exacerbate, apneas because, in contrast to the high sub atmospheric pressures used in non-invasive negative pressure ventilation, the sub atmospheric pressures we generate would be minimal, just enough to promote gentle and subtle expansion of the soft tissue structures of the neck without counteracting the preinspiratory contractile forces of the pharyngeal muscles.

Apneas tend to be worse when sleeping in the supine position as gravity makes it more likely for the uvula and tongue to fall towards the back wall of the throat, blocking the airway. Accordingly, another embodiment may include positional therapy in combination with negative pressure: a sloped pillow wedge may be designed into the device. This wedge may be placed on the back of the neck, tilting the chin and head backwards away from the chest, to help keep the airway open.

We teach two methods of true vacuum-style suction creation. The first has already been mentioned, namely, the use of a suctioning pumping means connected by a suction tube. The second one is fundamentally different. In essence, think of the rubber darts children play with. They have cup-shaped rubber faces. When wet, these will stick as suction cups. A stuck elastic suction cup has a reduced pressure behind it. So, in essence, we design our membrane so when pressed on the tissue, it is deformable with the hands-applied load in a manner that air is expelled from underneath by force past the leaking gasket or out a checkvalve. Upon manual release, the membrane wishes to elastically snap back to its relaxed shape but can't because the gasket seal won't admit the air required. Thus, the device is left with some hand-applied deformation of the membrane whose attempted recovery pulls a relative vacuum or suction between the membrane and the tissue. The attractiveness of this approach is the elimination of suction pumps and tubes. One could provide a pressure relief valve for easy device release in the morning. The wetting at the sealing edges or surfaces could be provided by a liquid or gel seal-ring for example or even by a wetting or very tacky adhesive.

In a third suction-equivalent embodiment, we replace the use of suction with the use of an adhesive. In this suction-equivalent approach, the membrane underside has an adhesive adhering to the underlying tissue instead of a vacuum. Note that this is more than adhesive sealing at the edges against leaks; it is outwardly pulling on the tissue as a vacuum would inside the seal periphery. In this approach, one preferably utilizes a membrane that elastically deforms when placed on the skin, thereby establishing membrane-adhesive contact. The membrane is then released and as it attempts to elastically reattain its undeformed state, it beneficially pulls outwardly on the tissues and adhesively pulls the tissue with it. This approach has the advantages that one doesn't need a suction gasket nor a vacuum generation means. It might also be beneficial to have the directional pulling of the adhesive as opposed to the omni-directional pulling (suction) of the vacuum. However, one would still likely place a soft strip at the membrane edge to spread the inward counteracting contact load and avoid discomfort. This approach also has the potential issue that the adhesive could progressively or suddenly fail, thereby losing the benefit of the device. Finally, the membrane backside adhesive would likely require significant inward loading to get it to adhere to tissues and this loading might be non-uniform and uncomfortable. In spite of these drawbacks, an adhesive approach versus a vacuum approach is probably workable, at least for short periods of wear and light outward adhesive loading. A “suction-equivalent” adhesive approach like this might have the adhesive situated upon or laminated to a somewhat compliant foam layer such that the adhesive can conform somewhat before it pulls upon release of the membrane.

Finally, the present inventors have noted that in addition to suctioning frontal areas of the neck to relieve an apnea issue, one may additionally benefit from inward compressive loading upon the adjacent sides of the neck which appear to beneficially deform the breathing passages open particularly when combined with frontal suctioning. Thus, in some embodiments, our device may laterally squeeze the sides of the neck as it also suctions a frontal portion of the neck or throat. Such squeezing may be provided such as by the device being elastically deformable on the sides.

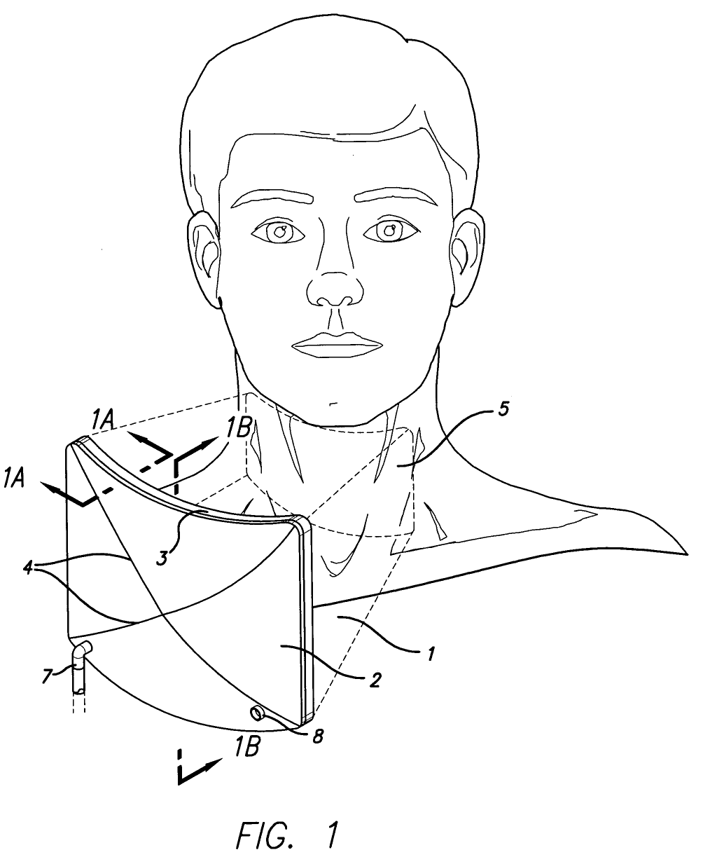

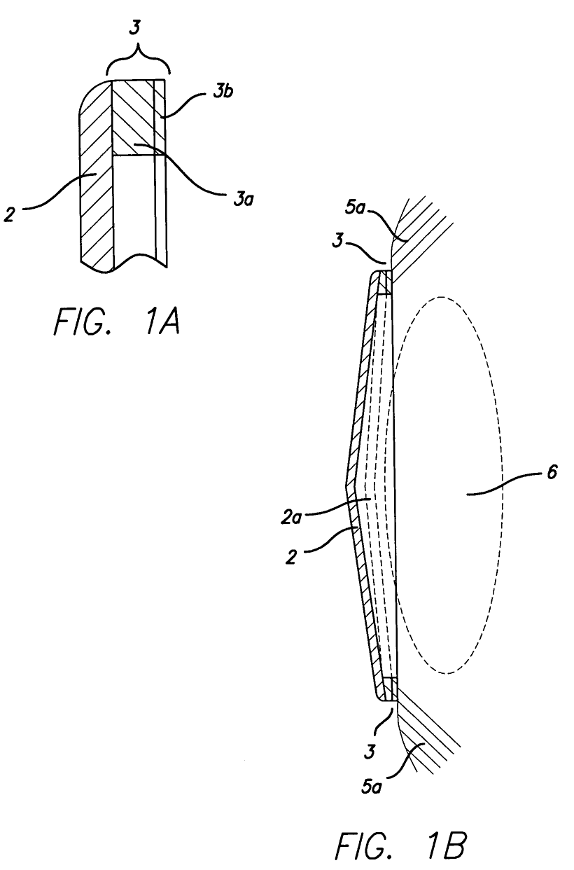

Turning now to the Figures, the inventive device 1 is depicted in FIG. 1, as well as two sections thereof, sections 1A-1A (FIG. 1A) and 1B-1B (FIG. 1B). FIG. 1 also depicts a wearer of the device but the wearer is not wearing it and is only depicted to indicate where it goes on the wearer's neck region 5. The present invention is not limited to application at this specific anatomical location nor to being symmetrically mounted.

Beginning with device 1, we see that it comprises a leak-tight membrane 2 with a peripheral gasket structure 3. The gasket structure 3 is depicted in FIG. 1A (shown enlarged approximately five times) to comprise, in some embodiments, a closed cell airtight conforming foam ring 3a and an overlying tissue-contacting adhesive or gel seal ring 3b. The purpose of the conforming ring 3a is primarily to provide fitting conformance to throat 5 local topographical variations and to provide standoff distance from throat 5 of membrane 2 to allow for membrane compression. We depict just one vacuum chamber behind the membrane 2 but there may be more than one, each possibly having its own gaskets.

FIG. 1B depicts the device in full section. We note that it is dome or pyramidal shaped in the undeflected (solid lines) condition 2. The pyramidal shape is shown as having reinforcing antibuckling edges or ridges 4 (see FIG. 1). When deflected upon the throat 5, the device has a compressed or deflected shape, indicated by phantom lines 2a in FIG. 1B. The deflected state wishes to elastically spring back to the undeflected state but the seals 3 prevent air from entering the membrane/tissue suctioned interface and thus prevent the elastic springing back to the undeflected state. Therefore, the suctioned interface remains at reduced pressure relative to the ambient. This reduced pressure air cavity effectively pulls on the throat tissues 5 under the membrane. This pulling or suction effect causes a region of throat tissues 6 to be decompressed from their otherwise collapsed OSA condition, thereby relieving or eliminating the OSA symptoms.

The tissue whereat the gasket 3 (layers 3a and 3b) seals against the throat tissues 5 is depicted as tissue 5a in FIG. 1B. It will again be appreciated that these regions are compressed in force-balance with the decompression forces acting on the suctioned tissue inside this perimeter.

Presuming a good seal at gasket system 3, the degree of suction or negative pressure created will be set by the suction implementation method. In the first case, we utilize a suction tube 7 (FIG. 1) connected to a suction pump or suctioning squeeze bulb (pump/bulb not shown). The suction creation method employed may apply a one-time suction or may continuously apply pumping suction to the device 1. In this continued-pumping approach, the membrane may be rigid and non-deflecting, as it does not have to produce a suction itself. In the second one-time approach, instead of utilizing a continuous-pumping suction pumping means, we instead utilize the desired elastic springback of a deformed elastic membrane to create the one-time suction. This desired but inhibited springback would be the membrane motion from a phantom position 2a to relaxed position 2 in FIG. 1B. That motion is inhibited because air cannot substantially leak past the gasket during one sleep period. The device 1 can therefore be held against the throat and pressed flatter such that air is expelled from the air chamber interface underneath either past the gasket or past a check valve such as item 8. Note that any seal has a leak rate and what is important here is that one designs the membrane such that, overnight, it still does not relax all the way back to its relaxed position 2; thus, it is still causing vacuum suction underneath it.

One might choose to also incorporate a strap or band passing around the entire neck (not shown) to assure that the patient's sleeping movements don't dislodge the device or cause a significant leak. Such a strap, band or wrap could attach at the device periphery or even overlay the device itself (not shown).

It will be recognized that regular use of the device may also contribute to a daytime reduction in passage constriction which carries over into the evening, even sometimes without wearing an otherwise regularly-worn device. This would be because the tissues actually adapt somewhat to their steady and regular loads by semi permanent distortions in those directions. This effect may wear off with extended nonuse.

The membrane may be fabricated of polymeric plastic as by molding or thermoforming, for example. The device may also be made of an elastic metal. We have shown in FIG. 1 the device having an undeformed pyramidal shape. Such a shape assures that the middle region of the membrane won't come into contact with the tissues during use and will be buckle-resistant. The device may also be made in part or in whole using stereolithography or other custom-fitted CAD based fabrication methods. One might utilize a laser scanner to acquire the neck topography to be fed to such a stereolithography tool. A malleable or deformable membrane which is fitted to the patient's neck is also within the scope of the present invention. Even after such fitting, the gasket seals would still provide leak resistance and some standoff distance from the tissue. The pyramidal shape might be replaced with a multi-stepped collapsible shape which might be more in the form of circular or rectangular mesas.

It will be recognized that our desired tissue-pulling suction (or adhesive) load is preferably applied everywhere under the membrane where the reduced pressure and/or pulling adhesive exists. It does not matter much what the gap is between the membrane and the tissue, only that a relative vacuum exists in that interface. It is preferred, however, to have some gap present as this will encourage ongoing additional outward tissue movement even for a rigid non-deforming membrane. A larger gap in the suction chamber also allows more air-leakage to be allowable. One might also sculpture the tissue-facing surface of the membrane to assure that it can't create a seal against the throat. We prefer that seal only at our gasket location(s). We include in the inventive scope the deployment of materials, lubricants, films or compliant pads in the gap that reduce friction between the membrane and any occasionally touching or continuously contacting tissue points. Ideally, these will not be totally forcefully collapsed by the suction but might be.

The device 1 might be reusable or disposable. A disposable device may likely utilize an adhesive or gel-based seal that wears out or dysfunctions after one or more uses. A reusable device may have a seal which is replaceable, such as a separable gel-seal that comes in a sealed pouch and is preferably purchased in quantity. One may also have a rubber gasket, replaceable or not, that is wetted by the user as with petroleum jelly or a cream, which affords a wetting suction seal. An amount of the wetting agent may be provided with the seal or with the device. In the case of an adhesive-based suction-equivalent, the adhesive member(s) may be replaceable.

The device may easily incorporate one or more sensors. Examples of sensors may include a pressure sensor underneath the membrane or a microphone on or in the membrane to detect snoring. Another may be an accelerometer to detect convulsive movements. The sensor(s) may provide feedback to a control unit or just simply exist as an emergency interlock for safety. The device and/or its control box (not shown in figure) may also contain a patient alert mechanism such as a buzzer or alarm tone to warn or wake the patient and/or his/her partner, if any, of a dangerous condition. Sensors may be provided to record breathing patterns such that a practitioner could assess whether the patient is changing over time with respect to the severity of his/her condition. Sensed parameters may also be provided to a wired or wireless data network for immediate or later use. Finally, one may utilize a sensor to determine when or if to deliver a cooperating drug or a cooperating electrodebased therapy.

In one of the simplest implementations, there are no sensors and no control box such as might include a pump. One would simply have the device itself elastically pressed upon the neck such that it remains leak-tight in a collapsed suctioning state. The same applies to a simple adhesive-based (vs. suction based) device.

What is claimed is:

1. A suction-establishing medical device for the treatment of sleep apnea mountable to a throat region useable to relax otherwise collapsed or potentially collapsing or contacting air-passage tissues comprising:
a neck mountable membrane or diaphragm capable of sustaining a pressure differential across its thickness, the pressure underneath it and adjacent the tissue being reduced relative to ambient pressure for at least a useful period;
a vacuum or suction seal mounted to the membrane, at or near its edges;
a vacuum or suction generation mechanism;
wherein the membrane with its suction seal being mountable on a patient's neck portion overlying a region which requires reversal or avoidance of tissue collapse, said membrane/seal having a preformed general shape that approximately conforms to the neck region to which it is applied, at least at the edge gasket, the gasket providing a pneumatic seal against the neck tissues; and
wherein the vacuum or suction generation mechanism is able to apply or maintain a vacuum after said gasket seal is achieved, thereby establishing an outward tissue-pulling suction force on the underlying adjacent tissues within the seal to be uncollapsed.

2. The device of claim 1 wherein the vacuum or suction generation mechanism comprises either a plumbed suction pumping mechanism or comprises the membrane and/or membrane gasket itself acting to create suction underneath it as by it being mounted and sealed to the neck with a membrane deflection and/or gasket compression that creates a suctioning action underneath it as it attempts to recover from that deflection and/or compression.

3. The device of claim 1 wherein the gasket is any one or more of:
utilizes a sealing gel;
utilizes a sealing adhesive;
utilizes a wetting flowable medium or liquid to support sealing;
is disposable;
is reusable;
is replaceable;
includes both a sealing material and a conforming or compressible material;
contributes to a beneficial suctioning effect;
provides anatomical conformance to a degree; or
makes the inward edge loading more comfortable.

4. The device of claim 1 wherein the membrane is sufficiently rigid or semi-rigid such that it can maintain a pressure differential across its thickness in at least one deflected or undeflected state without substantially collapsing and losing all or most of that suction.

5. The device of claim 1 wherein the membrane has an elastically deflected state whose desired recovery therefrom creates a suction beneath the membrane.

6. The device of claim 1 wherein any manner of continuously operating or periodically operated or operating suction-generation mechanism is utilized or applied.

7. The device of claim 1 wherein any manner of one-time operated suction generation mechanism is utilized or applied including as by attempted elastic recovery of the membrane and/or its gaskets from an applied one-time deflection or compression.

8. The device of claim 1 wherein a sealing gasket is also compressible and is compressed during device mounting, the gasket's desired elastic recovery from that compression also or instead causing beneficial suction beneath the membrane, said membrane itself being or not being also elastically deformed and providing or not providing a similar suctioning effect.

9. The device of claim 1 wherein the membrane is any one or more of: a) molded or cast, b) thermoformed, c) comprised substantially of a polymer, d) comprised of an elastic material, e) comprised of a deformable material, f custom-fit and fabricated utilizing stereolithography-like techniques, g) custom fit in any manner, h) shapeable, at least once, by the user or practitioner to some degree.

10. The device of claim 1 wherein the device includes a check valve or pressure relief valve for any purpose including such as for maintenance of suction or release of suction.

11. The device of claim 1 wherein the entire device is either reusable or disposable.

12. The device of claim 1 wherein any shape or dimension of the device is any one or more of:
chosen from a kit of multiple different devices or device portions;
formed to the anatomy at the time of use;
manufactured or fabricated by anyone to a particular customer's anatomy shape;
adjustable;
different for children versus adults; or
different for obese persons relative to non-obese persons.

13. The device of claim 1 wherein a sealing gasket includes any one or more of: a) a topographically conforming non-leaking layer, b) an adhesive layer, c) a gel-sealing or conforming layer, d) a rubber or elastomer portion, e) a sealing surface that is wetted or lubricated at any point, f) any replaceable portion, g) a closed-cell foam portion, h) a load-cushioning action, or i) a compressible portion which, upon its attempted recovery, contributes useful suctioning.

14. The device of claim 1 wherein it includes an additional fastener capability, including a strap, band or wrap to provide additional anatomy fixation beyond what the suction itself provides.

15. The device of claim 1 wherein it is placed against the throat and the membrane is deflected and/or the gasket is compressed, thereby expelling air from underneath the membrane past the gasket or out a check valve, and upon release of the deflecting and/or compressing force the membrane and/or gasket establishes a beneficial suction as it as it attempts to recover from said deflection or compression.

16. The device of claim 1 wherein it is placed against the throat and a suctioning or evacuation means creates a suction under the membrane and that suction is preserved as by the closure of a valve or sealing of a flowpath.

17. The device of claim 16 wherein the suction means is one of a) a pump, b) a squeeze bulb, or c) any kind of manually operated evacuation means.

18. The device of claim 1 wherein the membrane has the general shape of: a) a plate, b) a pyramid, c) a dome, d) a generally cylindrical or spherical shape, e) a generally symmetric shape, f) a generally trapezoidal shape, g) a generally rectangular shape, or h) a shape having stepped mesas.

19. The device of claim 1 wherein the device includes a jaw brace such that the patient is limited in his/her head articulation for any reason related to good or safe device operation.

20. The device of claim 1 wherein the device wraps around the neck to a degree, thus providing a radial decompression force to at least some neck tissues in the wrapping region.

21. The device of claim 1 wherein the suction magnitude is varied, including for at least one of:
timed operation with a breathing cycle;
triggered or adjusted operation with an apnea parameter or condition being sensed;
triggered or adjusted operation with a snoring parameter or condition being sensed; or
optimization of the devices overall benefit.

22. The device of claim 1 wherein snoring is reduced or avoided.

23. The device of claim 1 wherein unsafe breathing stoppages are reduced or avoided.

24. The device of claim 1 wherein it is used together with a drug or electrotherapeutic measure to cooperatively suppress or eliminate apnea, hypopnea events or hypoxic or hyperbaric episodes.

25. The device of claim 1 wherein it is used to treat any one or more of the following specific conditions or health states: a) sleep apnea, b) hypopnea, c) hypoxic episodes, d) hyperbaric episodes, or e) snoring.

26. The device of claim 1 wherein the device is used in cooperation with any of (n)-cPAP or BiPAP.

27. The device of claim 1 wherein said suction effect is instead provided by an adhering interface between the membrane and tissue, the deflected membrane and/or compressed gasket-seal providing outward or suction-equivalent loading of the tissues as said deflection and/or compression attempts to recover.

28. The device of claim 1 wherein also provided by the device is inward compression of the patient's neck on the side of the neck to further beneficially deform or open-up blocked breathing passages.

29. The device of claim 28 wherein said additional inward compression of the side(s) of the neck is provided by an elastic property of the device or by a device-fixating strap, wrap or clamp.
